(19) United States
(12) Patent Application Publication
(10) Pub. No.: US 2015/0365883 A1
(43) Pub. Date: Dec. 17, 2015

(54) METHOD FOR ENABLING THE MANAGEMENT OF AN ACCESS CONTROL LIST, A HOME NODEB MANAGEMENT SYSTEM AND CELLULAR COMMUNICATION SYSTEM THEREFOR

(71) Applicant: Ian Ross MACPHERSON, St. Neots Cambridgeshire (GB)

(72) Inventor: Ian Ross MACPHERSON, St. Neots Cambridgeshire (GB)

(21) Appl. No.: 14/349,475

(22) PCT Filed: Sep. 6, 2012
(86) PCT No.: PCT/EP2012/067396

§ 371 Date: Feb. 19, 2015

(30) Foreign Application Priority Data
Oct. 10, 2011 (GB) 1117460.4

(51) Int. Cl. H04W 48/16; H04W 12/08

(52) U.S. Cl. CPC H04W 48/16; H04W 12/08; H04W 84/045

(57) ABSTRACT

A method for enabling the management of an access control list (ACL) of a Home NodeB (HNB) within a cellular communication network is described. The method comprises receiving an ACL management message originating from a subscriber unit, identifying at least one HNB with which the originating subscriber unit of the received message is registered as being authorised to manage an ACL therefor, and performing at least one ACL management operation for the ACL of the identified HNB in accordance with the received ACL management message.

### FIELD OF THE INVENTION

The field of the invention relates to a method for enabling the management of an access control list (ACL). The invention is applicable to, but not limited to, a method for enabling the management of an access control list (ACL) of a Home NodeB (HNB) within a cellular communication network, and an HNB management system and cellular communication system therefor.

### BACKGROUND OF THE INVENTION

Wireless communication systems, such as the 3^{rd} Generation (3G) of mobile telephone standards and technology, are well known. An example of such 3G standards and technology is the Universal Mobile Telecommunications System (UMTS™), developed by the 3^{rd} Generation Partnership Project (3GPP™) (www.3gpp.org). The 3^{rd} generation of wireless communications has generally been developed to support macro-cell mobile phone communications. Such macro cells utilise high power base stations (NodeBs in 3GPP parlance) to communicate with wireless communication units within a relatively large geographical coverage area. Typically, wireless communication units, or User Equipment (UEs) as they are often referred to in 3G parlance, communicate with a Core Network (CN) of the 3G wireless communication system via a Radio Network Subsystem (RNS). A wireless communication system typically comprises a plurality of radio network subsystems, each radio network subsystem comprising one or more cells to which UEs may attach, and thereby connect to the network. Each macro-cellular RNS further comprises a controller, in a form of a Radio Network Controller (RNC), operably coupled to the one or more Node Bs, via a so-called I_{ub} interface.

Lower power (and therefore smaller coverage area) femto cells (or pico-cells) are a recent development within the field of wireless cellular communication systems. Femto cells or pico-cells (with the term femto cells being used hereafter to encompass pico-cells or similar) are effectively communication coverage areas supported by low power base stations (otherwise referred to as Access Points (APs) of Home Node B's (HNBs)). These femto cells are intended to be able to be piggy-backed onto the more widely used macro-cellular network and support communications to UEs in a restricted, for example ‘in-building’, environment.

Typical applications for such femto HNBs include, by way of example, residential and commercial (e.g. office) locations, communication ‘hotspots’, etc., whereby HNBs can be connected to a core network via, for example, the Internet using a broadband connection or the like. In this manner, femto cells can be provided in a simple, scalable deployment in specific in-building locations where, for example, UEs may come into close proximity to a femto HNB.

In order to enable a user (e.g. a consumer) to control that UEs that can register and receive services from their femto HNB, an Access Control List (ACL) for the femto HNB may be created and managed by a central HNB management system (HMS) of the network operator. The current industry model for a user to manage an ACL for their HNB is to utilize a web-based self-care portal for the HMS, or to call into a customer care service of the network operator.

A problem with utilising a web-based self-care portal is that it requires the user to power-up or otherwise gain access to a personal computer or other web-enabled device in order to access the self-care portal. The user is further required to have knowledge of the serial number of the HNB, which may be located, for example, in a different room to the personal computer, etc. In addition, the user is also required to remember authentication information, such as a username and password in order to access the self-care portal services. Similar problems exist when making a call to a customer care service of the network operator, as well as the need for the user to have knowledge of the telephone number to dial.

Thus, a need exists for enabling an improved management of an access control list (ACL) of a Home NodeB (HNB) within a cellular communication network.

### SUMMARY OF THE INVENTION

Accordingly, the invention seeks to mitigate, alleviate or eliminate one or more of the above mentioned disadvantages, singly or in any combination. Aspects of the invention provide a Home NodeB Management system, a cellular communication system, and a method therefor as described in the appended claims.

According to a first aspect of the invention, there is provided a method for enabling a management of an access control list (ACL) of a Home NodeB (HNB) within a cellular communication network. The method comprises receiving an ACL management message originating from a subscriber unit, identifying at least one HNB with which the originating subscriber unit of the received message is registered as being authorised to manage an ACL therefor, and performing at least one ACL management operation for the ACL of the identified HNB in accordance with the received ACL management message.

Thus, in one example embodiment of the invention, an access control list of a Home NodeB may be managed utilising access control list management messages sent from a subscriber unit, such as a user's mobile telephone handset.

According to an optional feature of the invention, the method may further comprise identifying the originating subscriber unit based at least partly on information contained within the received ACL management message. For example, the method may further comprise identifying the originating subscriber unit based at least partly on an originator Mobile Subscriber Integrated Services Digital Network Number (MSISDN) parameter within the received ACL management message. In this manner, identification and authentication of a user may be performed based on the originating subscriber unit, thereby substantially alleviating a need for additional authentication, such as by way of a username and password.

According to an optional feature of the invention, the method may comprise identifying an HNB with which the originating subscriber unit is registered as being authorised to manage an ACL therefor based at least partly on identifying at least one femto cell with which the originating subscriber unit is registered for service.

According to an optional feature of the invention, the method may comprise identifying an HNB with which the originating subscriber unit is registered as being authorised to manage an ACL therefor based at least partly on identifying at least one HNB with which the originating subscriber unit is registered with an HNB management system as being authorised to manage the ACL therefor.

According to an optional feature of the invention, the at least one ACL management operation may comprise at least one from a group comprising:
returning identifiers of subscriber units included within the ACL of the identified HNB;
modifying the ACL of the identified HNB to add a subscriber unit thereto; and
modifying the ACL of the identified HNB to remove a subscriber unit therefrom.

According to an optional feature of the invention, the at least one ACL management operation may comprise identifying a subject subscriber unit of the ACL management message, based at least partly on a subject subscriber field within the ACL management message, and obtaining subscriber profile data for the subject subscriber unit. For example, the method may comprise requesting subscriber profile data for the subject subscriber unit from an authentication, authorization and accounting (AAA) server of the cellular communication system. The subject subscriber field may comprise a subject subscriber Mobile Subscriber Integrated Services Digital Network Number (MSISDN) field.

According to an optional feature of the invention, the method may further comprise previously registering at least one subscriber unit as being authorised to manage at least one ACL of at least one HNB.

According to an optional feature of the invention, the method may further comprise previously establishing an ACL management messaging service within the cellular communication system.

According to an optional feature of the invention, the ACL management messaging service may utilise at least one messaging protocol from a group comprising:
unstructured supplementary service data (USSD) messaging protocol; and
short message service (SMS) messaging protocol.

According to an optional feature of the invention, the method may be implemented within an HNB management system operably coupled to the cellular communication network.

According to a second aspect of the invention, there is provided a Home NodeB (HNB) management system arranged to enable a management of an access control list (ACL) of at least one Home NodeB (HNB) within a cellular communication network. The HNB management system comprises at least one signal processing module arranged to receive an ACL management message, identify at least one HNB with which an originating subscriber unit of the received message is registered as being authorised to manage an ACL therefor, and perform at least one ACL management operation for the ACL of the identified HNB in accordance with the received ACL management message.

According to a third aspect of the invention, there is provided a cellular communication system comprising a Home NodeB (HNB) management system arranged to enable the management of an access control list (ACL) of at least one Home NodeB (HNB) within a cellular communication network. The HNB management system comprises at least one signal processing module arranged to receive an ACL management message, identify at least one HNB with which an originating subscriber unit of the received message is registered as being authorised to manage an ACL therefor, and perform at least one ACL management operation for the ACL of the identified HNB in accordance with the received ACL management message.

According to a fourth aspect of the invention, there is provided a non-transitory non-transitory computer program product having executable program code stored therein for enabling the management of an access control list (ACL) of a Home NodeB (HNB) within a cellular communication network. The program code operable for receiving an ACL management message originating from a subscriber unit, identifying at least one HNB with which the originating subscriber unit of the received message is registered as being authorised to manage an ACL therefor, and performing at least one ACL management operation for the ACL of the identified HNB in accordance with the received ACL management message.

These and other aspects of the invention will be apparent from, and elucidated with reference to, the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding.

FIG. 1 illustrates an example of part of a cellular communication system.

FIG. 2 illustrates an example of the cellular communication system of FIG. 1 adapted in accordance with some example embodiments of the present invention.

FIG. 3 illustrates a simplified example of a message flow diagram that may be applied in some example embodiments of the present invention.

FIG. 4 illustrates a simplified example of a message flow diagram that may be applied in some alternative example embodiments of the present invention.

FIGS. 5 and 6 illustrate simplified flowcharts of an example of a method for enabling the management of an access control list (ACL) of a Home NodeB (HNB) within a cellular communication network.

FIG. 7 illustrates a typical computing system that may be employed to implement signal processing functionality in example embodiments.

### DETAILED DESCRIPTION

Examples of the invention will be described in terms of a network element within a 3rd generation (3G) Radio Network Sub-system (RNS) for supporting one or more femto cells within a Universal Mobile Telecommunications System (UMTS™) cellular communication network. However, it will be appreciated by a skilled artisan that the inventive concept herein described may be embodied in any type of network element for supporting communications within a cellular communication network. In particular, it is contemplated that the inventive concept is not limited to being implemented within a network element for supporting one or more femto cells within a UMTS™ cellular communication network, but may be equally applied within one or more network element(s) adapted to support any type of cell, e.g. one or more macro cells, and/or adapted in accordance with alternative cellular communication technologies.

In a number of applications, the adaptation of a Home NodeB (HNB) management system in accordance with examples of the invention may effectively perform a method for enabling the management of an access control list (ACL) of a HNB within a cellular communication network. The method comprises receiving an ACL management message originating from a subscriber unit, identifying at least one HNB with which the originating subscriber unit of the received message is registered as being authorised to manage an ACL therefor, and performing at least one ACL management operation for the ACL of the identified HNB in accordance with the received ACL management message.

In this manner, a user of a subscriber unit authorised to manage an ACL for an HNB may initiate ACL management operations by way of ACL management messages using their subscriber unit, e.g. their mobile telephone handset. Significantly, such a method enables the user to directly manage an ACL list via their subscriber unit, thereby substantially alleviating a known need to utilise a web-based self-care portal service or customer care service.

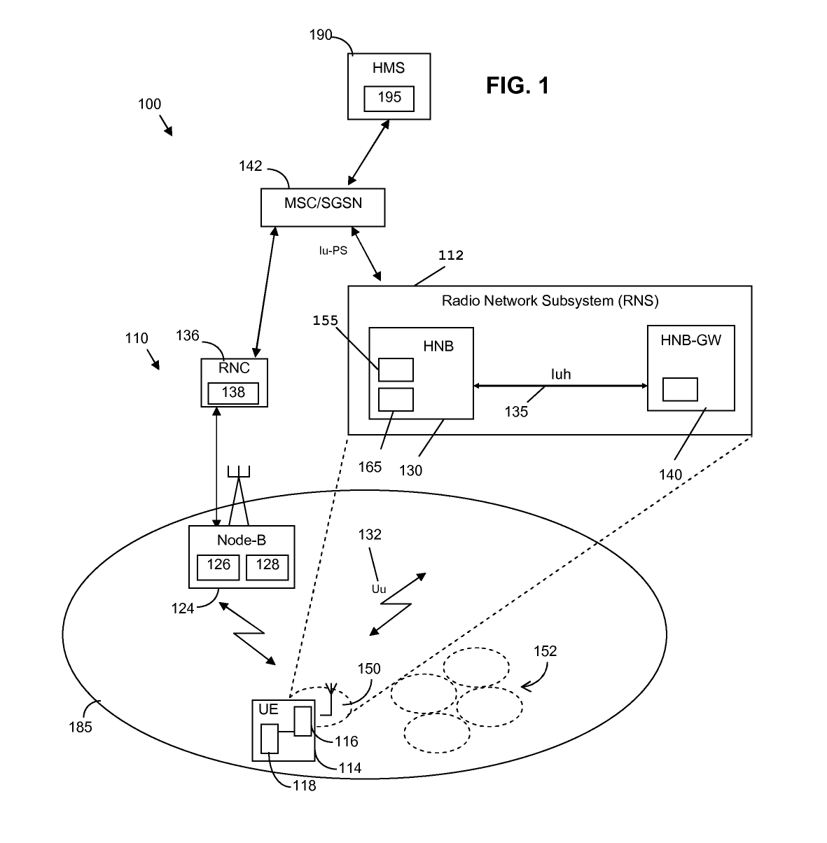

Referring now to the drawings, and in particular FIG. 1, an example of part of a cellular communication system, adapted in accordance with an example embodiment of the invention, is illustrated and indicated generally at 100. In FIG. 1, there is illustrated an example of a communication system in a form of a 3GPP™ UMTS™ network 100 that comprises a combination of a macro cell 185 and a plurality of femto cells 150, 152. For the example embodiment illustrated in FIG. 1, radio network sub-systems (RNSs) comprise two distinct architectures to handle the respective macro cell and femto cell communications.

In the macro cell scenario, the RNS 110 comprises a controller in a form of a Radio Network Controller (RNC) 136 having, inter alia, one or more signal processing module(s) 138. The RNC 136 is operably coupled to at least one NodeB 124 for supporting communications within the macro cell 185. The NodeB 124 comprises signal processing module 126 and transceiver circuitry 128 arranged to enable communication with one or more wireless communication units located within the general vicinity of the macro communication cell 185, such as User Equipment (UE) 114. The RNC 136 is further operably coupled to a core network element 142, such as a serving general packet radio system (GPRS) support node (SGSN)/mobile switching centre (MSC), as known.

In a femto cell scenario, an RNS 112 comprises an access point, 130, also known as a Home NodeB (HNB), that is arranged to perform a number of functions generally associated with a cellular communication base station, and a controller in a form of a Home NodeB Gateway (HNB-GW) 140. As will be appreciated by a skilled artisan, an HNB is a communication element that supports communications within a communication cell, such as a femto cell 150, and as such may provide access to a cellular communication network via the femto cell 150. One envisaged application is that an HNB 130 may be purchased by a member of the public and installed in their home. The HNB 130 may then be connected to an HNB-GW 140 via an Iᵤₕ interface 135, for example implemented over, say, the owner's broadband internet connection (not shown).

Thus, an HNB 130 may be considered as encompassing a scalable, multi-channel, two-way communication device that may be provided within, say, residential and commercial (e.g. office) locations, communication ‘hotspots’ etc., to extend or improve upon network coverage within those locations. An example of a typical 3G HNB for use within a 3GPP™ system may comprise some NodeB functionality and some aspects of radio network controller (RNC) 136 functionality. For the illustrated example embodiment, the HNB 130 comprises signal processing module 165 and transceiver circuitry 155 arranged to enable communication with one or more wireless communication units located within the general vicinity of the femto communication cell 150, such as User Equipment (UE) 114, via a wireless interface (Uu) 132.

The 3G HNB-GW 140 may be coupled to the core network (CN) via a support general packet radio system (GPRS) support node (SGSN) or main switching centre (MSC) 142 via an Iu interface, such as the packet switched Iu interface, Iu-PS, as shown. In this manner, the HNB 130 is able to provide voice and data services to a cellular handset, such as UE 114, in a femto cell, in the same way as a conventional NodeB would in a macro cell, but with the deployment simplicity of, for example, a Wireless Local Area Network (WLAN) access point.

An HNB management system (HMS) 190 may be coupled to the cellular communication system 100, and arranged to provide HNB management services such as, by way of example, access control list management, automated HNB configuration, etc. Accordingly, the HMS 190 comprises one or more signal processing modules, illustrated generally at 195, programmable for providing such functionality. The HMS 190 may be operably coupled to the cellular communication system 100 by way of any suitable interface, such as the OneAPI being currently being developed by the GSM Association (for more details see http://www.gsm.org).

The example cellular communication system 100 illustrated in FIG. 1, may comprise one or more network elements for supporting communication within one or more cells of the communication system 100, such as the femto HNB 130.

As previously mentioned, the current industry model for a user to manage an ACL for their HNB 130 is to utilize a web-based self-care portal for the HMS 190, or to call into a customer care service of the network operator. A problem with utilising a web-based self-care portal is that it requires the user to power-up or otherwise gain access to a personal computer or other web-enabled device in order to access the self-care portal. The user is further required to have knowledge of the serial number of the HNB 130, which may be located, for example, in a different room to the personal computer etc. In addition, the user is also required to remember authentication information such as a username and password in order to access the self-care portal services. With the exception of the need for the user to have access to a personal computer or other web-enabled device, similar problems exist when making a call to a customer care service of the network operator, as well as the need for the user to have knowledge of the telephone number to dial.

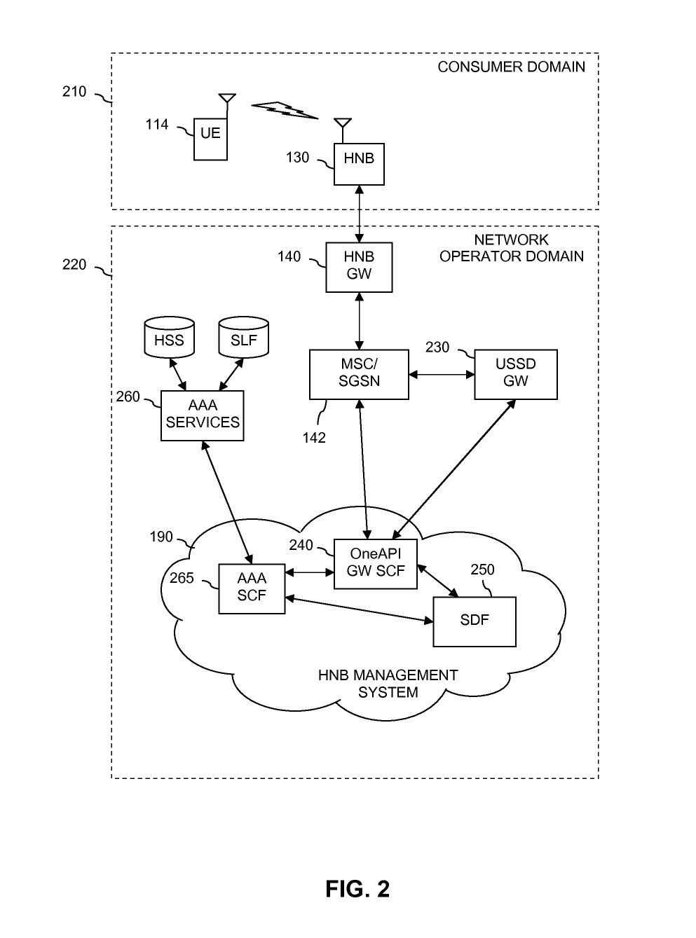

FIG. 2 illustrates an example of the cellular communication system 100, adapted in accordance with some example embodiments of the present invention. In FIG. 2, the cellular communication system 100 has been illustrated as comprising a consumer domain 210 comprising one or more subscriber units, such as UE 114, and one or more HNBs, such as HNB 130. The cellular communication system 100 further comprises a network operator domain 220 comprising radio network sub-system and core network elements such as, for the illustrated example, the HNB GW 140, MSC/SGSN 142, etc. In the illustrated example, the network operator domain 220 further comprises the HMS 190.

In accordance with some example embodiments of the present invention, a signal processor within a network element within the network operator domain 220, for example within the HMS 190, is arranged to receive an ACL management message originating from a subscriber unit, such as the UE 114, identify at least one HNB with which the originating subscriber unit of the received message is registered as being authorised to manage an ACL therefor, and perform at least one ACL management operation for the ACL of the identified HNB in accordance with the received ACL management message.

Such an ACL management message may comprise any suitable format. For some examples of the present invention, such ACL management messages may comprise existing messaging protocol. For example, such an ACL management message may comprise an unstructured supplementary service data (USSD) messaging protocol. USSD, defined in 3GPP™ technical specifications TS 22.090 and TS 23.090, is a messaging protocol used by GSM and 3G cellular telephones to communicate with the network operator domain. USSD messages are up to 182 alphanumeric characters in length. Unlike Short Message Service (SMS) messages, USSD messages create a real-time connection during a USSD session. The connection remains open, allowing a two-way exchange of a sequence of data. This makes USSD more responsive than services that use SMS.

For consistency and ease of understanding, the invention is hereinafter described with reference to the use of USSD messaging. However, alternative messaging protocols may equally used to implement the ACL management message herein described. For example, such an ACL management message may alternatively utilise the SMS messaging protocol.

In order for such ACL management messages to be appropriately handled within the network operator domain 220, it is contemplated that an ACL management messaging service may previously be established within the cellular communication system. For example, the HMS 190 may be arranged to send one or more USSD notification subscription messages to a USSD gateway 230 in order to register, or otherwise establish, one or more USSD codes for use as ACL management messaging codes. For example, the HMS 190 may be arranged to register a single USSD code for use as an ACL management messaging code. A typical USSD message starts with an asterisk (*) followed by digits that comprise commands or data. The message is terminated with a hash (#). In this manner, such an ACL management messaging code may be used to define a USSD message as being an ACL management message, with further identifiers within the message defining required ACL management operations to be performed, etc. Conversely, the HMS 190 may be arranged to register a plurality of USSD codes for use as ACL management messaging codes; each such ACL management messaging code corresponding to a specific ACL management messaging operation, or set of operations.

As illustrated in FIG. 2, the HMS 190 may be coupled with the more conventional cellular communication elements within the network operator domain 220 by way of a OneAPI interface. Accordingly, the HMS 190 of FIG. 2 comprises a OneAPI gateway (GW) service control function (SCF) 240, arranged to manage communication with, for example, telecommunication network elements within the network operator domain 220, such as the USSD gateway 230, MSC/SGSN 142, etc. In this manner, the HMS 190 may send one or more USSD notification subscription messages to the USSD gateway 230 via the OneAPI interface. Furthermore, a user of the UE 114 is subsequently able to initiate ACL management operations substantially directly using USSD messages, which may be routed to the HMS 190 over the OneAPI interface by the USSD GW 230.

Upon receipt of an ACL management message, the HMS 190 may be arranged to identify the originating subscriber unit for the received message, based at least partly on information contained within the received ACL management message. For example, the originating subscriber unit may be identified based on an originator Mobile Subscriber Integrated Services Digital Network Number (MSISDN) parameter within the received ACL management message. Advantageously, the MSISDN of an originating subscriber unit is automatically included within USSD and SMS messages in accordance with existing 3GPP technical specifications. Thus, no modifications to such existing protocols are required to achieve this.

Having identified the originating subscriber unit, for example UE 114, the HMS 190 may then identify an HNB with which the originating subscriber unit of the received message is registered as being authorised to manage an ACL therefor. For example, the HMS 190 may search for a femto cell with which the originating subscriber unit is currently registered for service. In this manner, the HMS 190 may identify the HNB supporting such a femto cell with which the originating subscriber unit is currently registered for service, such as HNB 130. For some example embodiments, the originating subscriber unit being registered for service with a femto cell may be deemed sufficient authorisation for that subscriber unit to manage an ACL for the supporting HNB 130.

However, for some alternative example embodiments, further authorisation may be required in order for an originating subscriber unit to manage an ACL for an HNB. For example, SIM (subscriber identity module) details for a key account holder for the HNB 130, such as IMSI and primary MSISDN, held within a billing support system (BSS) (not shown) of the cellular communication network 100 may be provisioned within a service data function (SDF) 250 of the HMS 190 at the point of creation of the femto cell 150 (FIG. 1) supported by the HNB 130. Accordingly, the MSISDN of the originating subscriber unit may be compared with primary MSISDNs of key account holders registered for the HNB 130 supporting the femto cell with which the originating subscriber unit is currently registered for service (and thus of subscribers authorised to manage ACLs therefor) held within the SDF 250.

In this manner, an HNB for which ACL management is required may be automatically identified by way of the subscriber unit from which an ACL management message originates. Thus, a user is not required to have knowledge of the serial number of the HNB in order to manage the ACL therefor. Furthermore, no additional authentication is required, such as the user providing a username and password or the like.

Alternatively, the HMS 190 may search for an HNB with which the MSISDN of the originating subscriber unit has been registered as a primary MSISDN of a key account holder. In this manner, the HMS 190 may identify an HNB for which the originating subscriber unit is authorised to manage the ACL, irrespective of whether or not the originating subscriber unit is currently registered for service within a femto cell supported thereby. In this manner, a key account holder need not be present (e.g. at home) in order to enabling a functionality of adding/removing other subscriber units to the ACL.

Having identified at least one HNB with which the originating subscriber unit is registered as being authorised to manage an ACL therefor, the HMS 190 may then perform at least one ACL management operation for the ACL of the identified HNB in accordance with the received ACL management message. For example, the HMS 190 may extract an ACL request code from the received message in order to determine a required ACL management operation. Alternatively, and as described above, the HMS 190 may determine a required ACL management operation based on, say, the particular USSD code of the received ACL management message.

ACL management operations that may be required to be performed may comprise, by way of example only, one or more of:
returning identifiers of subscriber units included within the ACL of the identified HNB;
modifying the ACL of the identified HNB to add a subscriber unit thereto; and
modifying the ACL of the identified HNB to remove a subscriber unit therefrom.

For example, where the ACL management operation comprises, say, returning identifiers of subscribers included within the ACL of the identified HNB, the ACL management operation may comprise retrieving the ACL (for example comprising a list of primary MSISDNs for which access is permitted) for the identified HNB 130 from the SDF 250, and returning the retrieved list to the originating subscriber unit.

Where the ACL management operation comprises, say, modifying the ACL to add a subscriber unit thereto, the ACL management operation may comprise identifying a subject subscriber unit of the ACL management message based at least partly on a subject subscriber field within the ACL management message. Such a subject subscriber field may comprise an MSISDN field for the subject subscriber unit.

Such an operation may further comprise requesting subscriber profile data for the subject subscriber unit from an authentication, authorization and accounting (AAA) server 250 of the cellular communication network 100. Accordingly, the HMS 190 may comprise an AAA service control function 255 arranged to communicate with the AAA server 250 via the OneAPI interface GW 240. Such subscriber profile data may comprise, for example, an IMSI (International Mobile Subscriber Identity) number associated with the MSISDN for the subject subscriber unit. Having received such profile information, the HMS 190 may then, in this example, add the MSISDN and IMSI pair for the subject subscriber unit to the ACL for the HNB 130.

Where the ACL management operation comprises, say, modifying the ACL to remove a subscriber unit therefrom, the ACL management operation may comprise identifying a subject subscriber unit of the ACL management message based at least partly on a subject subscriber field, for example an MSISDN field for the subject subscriber unit, within the ACL management message, and removing any entries within the ACL corresponding to the value indicated within such a field.

Having performed the required ACL management operation, the HMS 190 may then send an acknowledgement message, or a message comprising requested ACL information, back to the originating subscriber unit to confirm completion of the requested ACL management operation.

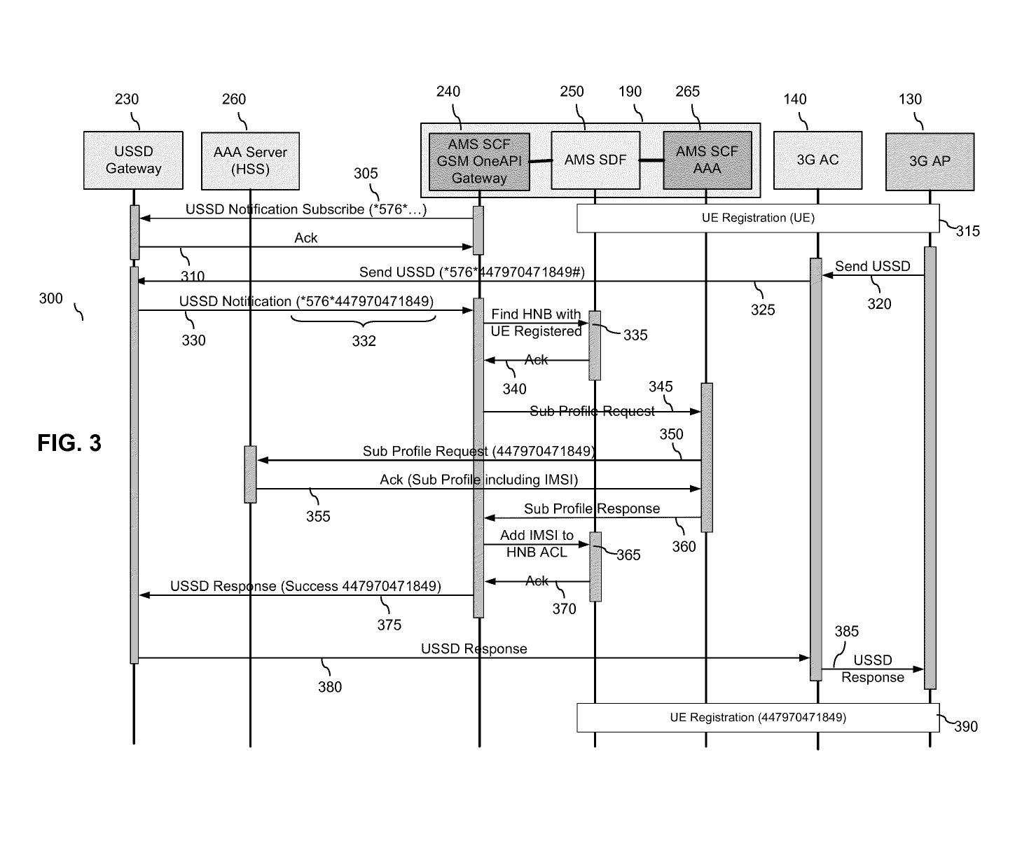

FIG. 3 illustrates a simplified example of a message flow diagram 300 for some example embodiments of the present invention. The message flow starts with a USSD notification subscription message 305 being sent from the HMS 190, and specifically from the OneAPI gateway 240 of the HMS 190, to the USSD gateway 230 to establish a USSD ACL management messaging service. For the illustrated example, the HMS 190 sends a notification subscription message 305 to establish the USSD code ‘576’ as a USSD ACL management messaging service code, such that USSD messages comprising the code ‘576’ are subsequently forwarded to the HMS 190. The USSD gateway 230 responds with an acknowledgement message 310 confirming the establishment of the USSD service. A subscriber unit, such as UE 114, which has previously registered 315 with the HNB 130, then sends a USSD ACL management message 320 comprising the USSD code ‘576’ to the HNB gateway 140, which forwards the USSD ACL management message to the USSD gateway 230, as illustrated at 325.

In some examples, it is noted that the UE is not required to be registered with the HNB 130 in order to be able to send USSD management messages, as USSD ACL management messages may be sent from any cell, even though the specific example provided in FIG. 3 assumes that the UEs are registered on their actual HNB, as the UE uses location presence messages 335 & 340 to find the HNB as illustrated below. Upon receipt of the USSD message 325, the USSD gateway 230 identifies the code ‘576’ as being an ACL management message, and accordingly forwards the USSD message 325 to the HMS 190, and specifically to the OneAPI gateway 240 of the HMS 190 as illustrated at 330.

Upon receipt of the ACL management message 330, the OneAPI gateway extracts an MSISDN of the originating subscriber unit from an envelope (not shown) of the received message to identify the originating subscriber unit. In the illustrated example, the OneAPI gateway 240 of the HMS 190 then queries 335 the server data function (SDF) 250 to find an HNB with which the originating subscriber unit is registered, which in the illustrated example is the HNB 130. The server data function 250 then responds with an acknowledgement message 340 identifying the HNB 130 with which the originating subscriber unit is registered.

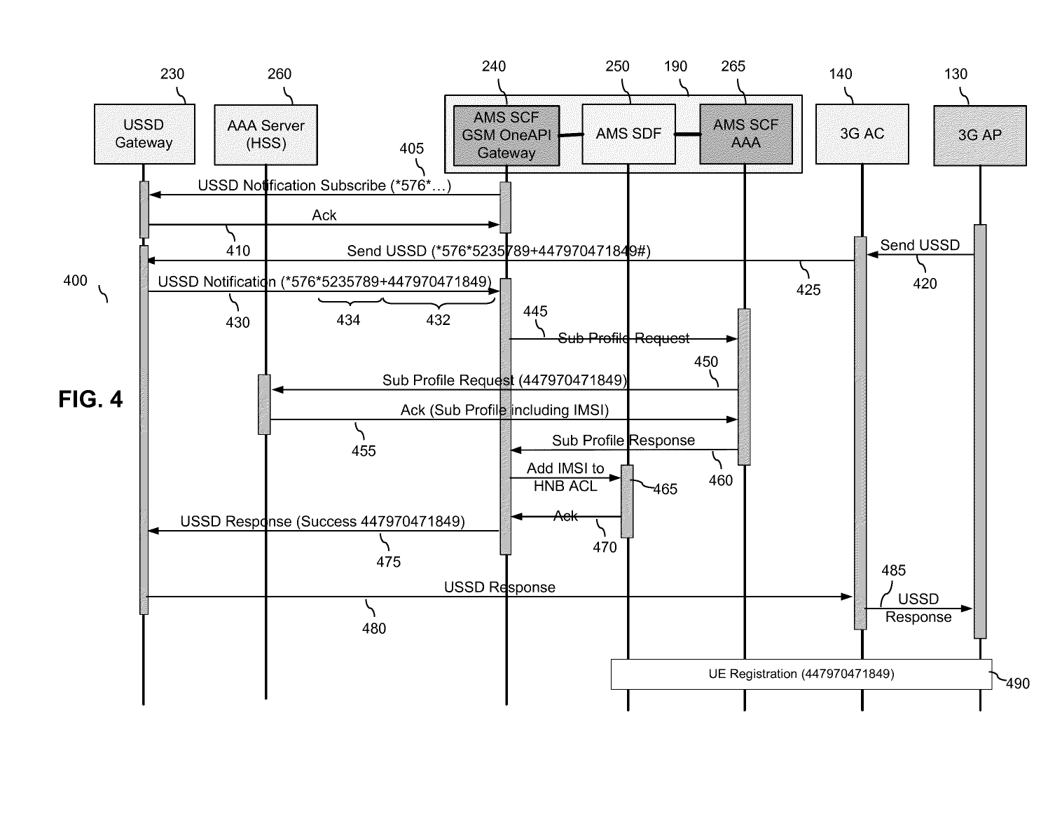

Notably, in some examples, the USSD string may be subtly different from the USSD string in FIG. 4, in that it may include two values after *576* with the first value being the AP Serial Number. In some examples, it is also possible to search for the HNB in a cell where the originating subscriber unit is the key account holder in order for another subscriber to be added to the ACL.

The server data function 250 may additionally determine whether the originating subscriber unit is authorised to modify the ACL for the identified HNB, for example based on whether the originating subscriber unit has been registered as belonging to a key account holder for the identified HNB 130, and to only respond with a positive acknowledgement message 340 if it is determined that the originating subscriber unit has been registered as belonging to a key account holder for the identified HNB 130.

For the example illustrated in FIG. 3, the ACL management message 330 is intended to modify the ACL of the HNB 130 to add a subscriber unit thereto. Accordingly, upon receipt of the acknowledgement message 340 from the server data function 250, the OneAPI gateway 240 requests 345 from the AAA service control function (SCF) 265 of the HMS 190 a sub-profile for a subject subscriber unit identified by way of an MSISDN contained within the USSD ACL management message 330, as indicated at 332. The AAA SCF 265 forwards 350 the request to the AAA server 260, which responds 355 with an acknowledgement message comprising sub-profile data for the indicated MSISDN 332, for example including an IMSI etc., therefor. The AAA SCF 265 then forwards 360 the received acknowledgement message to the OneAPI gateway 240. Upon receipt of the acknowledgement message 260, the OneAPI gateway sends a request 365 to the server data function 250 within the HMS 190 to add the MSISDN and IMSI pair for the subject subscriber unit to the ACL for the HNB 130. Upon receipt of an acknowledgement 370 from the server data function 250, the OneAPI gateway 240 sends a success response 375 back to the USSD gateway 230 for forwarding 380, 385 to the originating subscriber unit via the HNB gateway 140 and HNB 130. In this manner, the ACL of the HNB 130 is modified to include the subject subscriber unit, which is subsequently able to register with the HNB 130, as illustrated at 390.

FIG. 4 illustrates a simplified example of a message flow diagram 400 for some alternative example embodiments of the present invention. The message flow starts with a USSD notification subscription message 405 being sent from the HMS 190, and specifically from the OneAPI gateway 240 of the HMS 190, to the USSD gateway 230 to establish a USSD ACL management messaging service. In some examples, and in accordance with the example in FIG. 4, it is noted that the UE is not required to be registered with the HNB 130 in order to be able to send USSD management messages, as USSD ACL management messages may be sent from any cell. In some examples, it is also possible to search for the HNB in a cell where the originating subscriber unit is the key account holder in order for another subscriber to be added to the ACL.

For the illustrated example, the HMS 190 sends a notification subscription message 405 to establish the USSD code ‘576’ as a USSD ACL management messaging service code, such that USSD messages comprising the code ‘576’ are subsequently forwarded to the HMS 190. The USSD gateway 230 responds with an acknowledgement message 410 confirming the establishment of the USSD service. A subscriber unit, such as UE 114, then sends a USSD ACL management message 420 comprising the USSD code ‘576’ to the HNB gateway 140, which forwards the USSD ACL management message to the USSD gateway 230, as illustrated at 425. Upon receipt of the USSD message 425, the USSD gateway 230 identifies the code ‘576’ as being an ACL management message, and accordingly forwards the USSD message 425 to the HMS 190, and specifically to the OneAPI gateway 240 of the HMS 190 as illustrated at 430.

For the example illustrated in FIG. 4, the ACL management message 430 is intended to modify the ACL of the HNB 130 to add a subscriber unit thereto, and comprises a serial number ‘5235789’ or other identifier for the HNB 130, as indicated at 434. Accordingly, upon receipt of the ACL management message 430, the OneAPI gateway 240 requests 445 from the AAA service control function (SCF) 265 of the HMS 190 a sub-profile for a subject subscriber unit identified by way of an MSISDN contained within the USSD ACL management message 430, as indicated at 432. The AAA SCF 265 forwards 450 the request to the AAA server 260, which responds 455 with an acknowledgement message comprising sub-profile data for the indicated MSISDN 432, for example including an IMSI etc. therefor. The AAA SCF 265 then forwards 460 the received acknowledgement message to the OneAPI gateway 240. Upon receipt of the acknowledgement message 260, the OneAPI gateway sends a request 465 to the server data function 250 within the HMS 190 to add the MSISDN and IMSI pair for the subject subscriber unit to the ACL for the HNB 130. Upon receipt of an acknowledgement 470 from the server data function 250, the OneAPI gateway 240 sends a success response 475 back to the USSD gateway 230 for forwarding 480, 485 to the originating subscriber unit via the HNB gateway 140 and HNB 130. In this manner, the ACL of the HNB 130 is modified to include the subject subscriber unit, which is subsequently able to register with the HNB 130, as illustrated at 490.

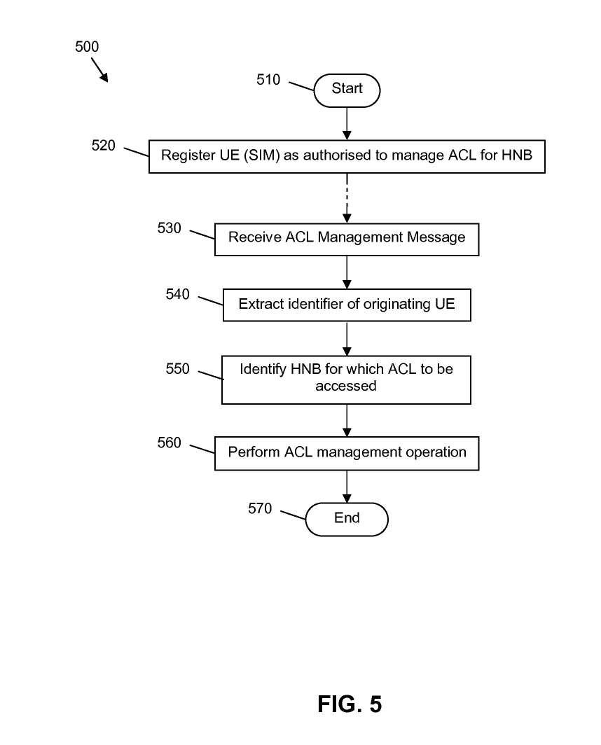

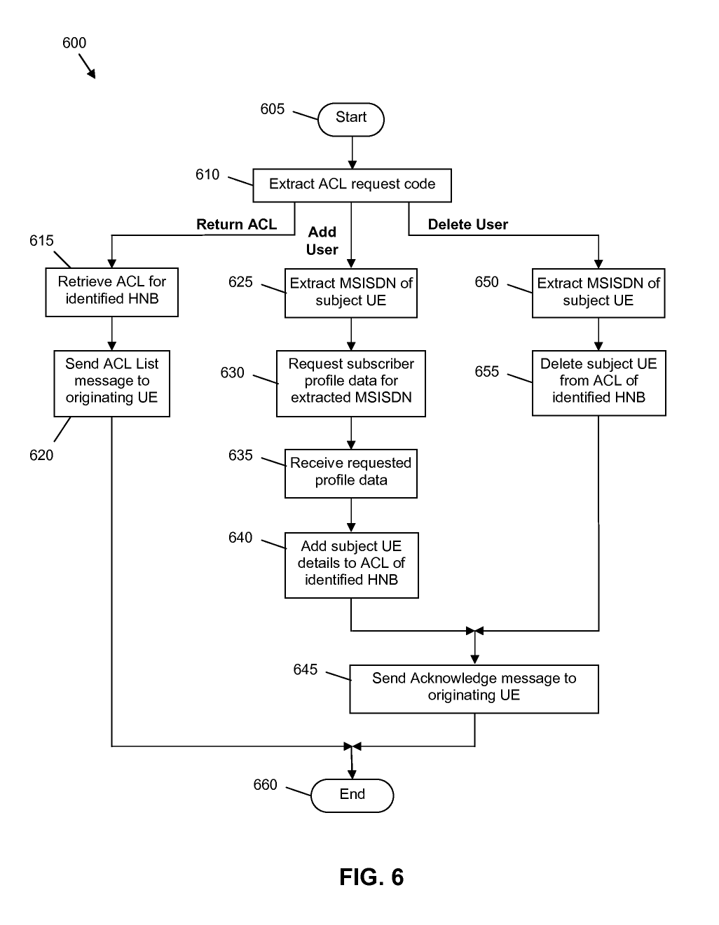

Referring now to FIGS. 5 and 6, there are illustrated simplified flowcharts 500, 600 of an example of a method for enabling a management of an access control list (ACL) of a Home NodeB (HNB) within a cellular communication network. The method starts at 510 in FIG. 5, and moves on to 520 with a subscriber unit, such as a SIM (subscriber identity module) within UE 114, being registered as authorised to manage an ACL of (at least one) HNB, for example by way of the subscriber unit being registered as belonging to a key account holder of the HNB. Subsequently, at 530, an ACL management message is received. An identifier of an originating subscriber unit, such as the MSISDN of the originating subscriber unit, is then extracted (or otherwise retrieved) at 540. An HNB for which the ACL is to be modified or otherwise accessed is then identified at 550. For example, an HNB for which the originating subscriber unit is authorised to manage the ACL for may be identified, or with which the originating subscriber unit is currently registered may be identified. Step 550 may further comprise determining whether (or not) the originating subscriber unit is authorised to manage the identified ACL, and taking any appropriate action in response to such a determination, such as sending a request failed message back to the originating subscriber unit, should it be determined that the originating subscriber unit is not authorised to manage the identified ACL. Having identified an HNB for which the ACL is to be accessed (and if necessary determining that the originating subscriber unit is authorised to make such an access), a required ACL management operation is then performed at 560, and the method ends at 570.

The simplified flowchart 600 of FIG. 6 illustrates an example of steps for performing a required ACL management operation, such as may be implemented at 560 in the flowchart of FIG. 5. The flowchart of FIG. 6 starts at 605, and moves on to 610 where an ACL request code is extracted from the ACL management message received at 530, and the required ACL management operation is determined. For the illustrated example, the ACL management operation may comprise returning the ACL, adding a subscriber unit to the ACL or deleting a subscriber unit from the ACL.

Where the ACL management operation comprises returning the ACL, the method moves on to 615 where the ACL, or at least a set of entries for the ACL such as MSISDNs, is retrieved, for example from the service data function 250 illustrated in FIG. 2. The retrieved ACL, or entries therefor, is/are then returned to the originating subscriber unit, for example within a USSD acknowledgement message, at 620. This part of the method then ends at 660.

Where the ACL management operation comprises modifying the ACL to add a user, the method moves on to 625 where an MSISDN of a subject subscriber unit is extracted from the received ACL management message. Subscriber profile data is then requested for the extracted MSISDN at 630. Upon receipt of the requested subscriber profile data, for example comprising an IMSI, etc., associated with the extracted subject subscriber unit MSISDN at 635, the method moves on to 640 where the subject subscriber unit details (e.g. MSISDN and IMSI pair etc.) are added to the ACL. An acknowledgement message is then sent to the originating subscriber unit at 645, and this part of the method then ends at 660.

Where the ACL management operation comprises modifying the ACL to delete a user, the method moves on to 650 where an MSISDN of a subject subscriber unit is extracted from the received ACL management message. Entries within the ACL for the extracted MSISDN are then deleted at 655. An acknowledgement message is then sent to the originating subscriber unit at 645, and this part of the method then ends at 660.

Advantageously, the method and apparatus for enabling a management of an access control list (ACL) of a Home NodeB (HNB) within a cellular communication network, as herein before described, substantially alleviates the need for a network operator to develop and deploy a web-based self-care portal to allow consumers to manage their HNB access control lists, or to provide a customer care service therefor. Furthermore, no username or password is required for authenticating the consumer prior to being authorised to manage the access control list, and the consumer is not required to know the serial number of the HNB. Additionally, for some example embodiments, the inventive concept may advantageously be implemented using incumbent messaging services such as USSD and/or SMS messaging services, thereby substantially alleviating the need for significant additional support services to be implemented.

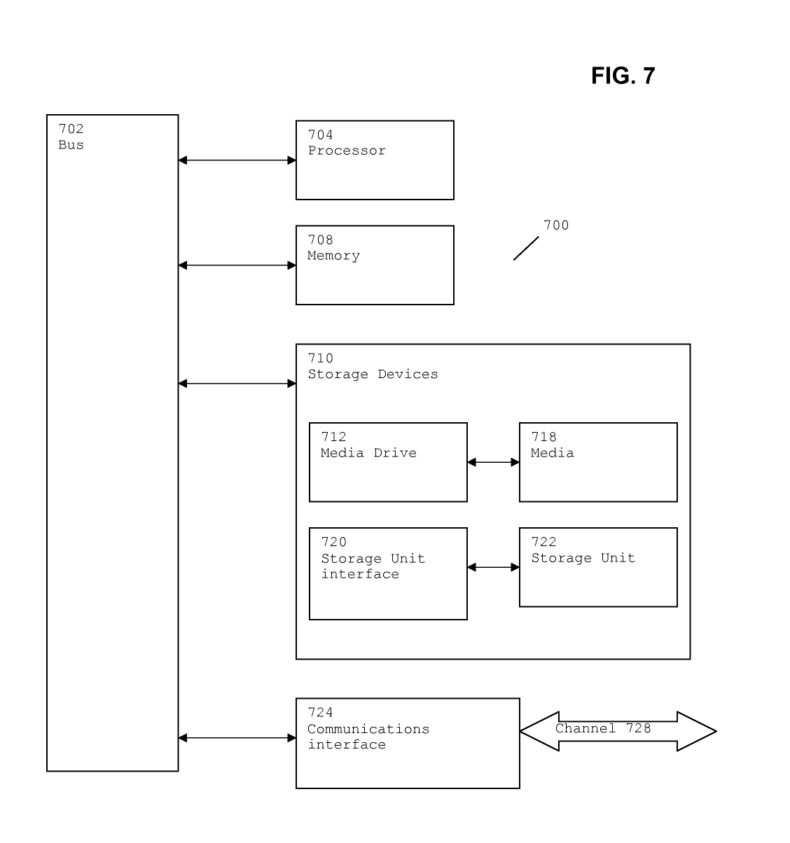

Referring now to FIG. 7, there is illustrated a typical computing system 700 that may be employed to implement signal processing functionality in embodiments of the invention. Computing systems of this type may be used in HNB management systems, core network and network sub-system network elements, access points (HNBs), base transceiver stations and wireless communication units. Those skilled in the relevant art will also recognize how to implement the invention using other computer systems or architectures. Computing system 700 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 700 can include one or more processors, such as a processor 704. Processor 704 can be implemented using a general or special-purpose processing engine such as, for example, a microprocessor, microcontroller or other control module. In this example, processor 704 is connected to a bus 702 or other communications medium.

Computing system 700 can also include a main memory 708, such as random access memory (RAM) or other dynamic memory, for storing information and instructions to be executed by processor 704. Main memory 708 also may be used for storing temporary variables or other intermediate information during execution of instructions to be executed by processor 704. Computing system 700 may likewise include a read only memory (ROM) or other static storage device coupled to bus 702 for storing static information and instructions for processor 704.

The computing system 700 may also include information storage system 710, which may include, for example, a media drive 712 and a removable storage interface 720. The media drive 712 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 718 may include, for example, a hard disk, floppy disk, magnetic tape, optical disk, CD or DVD, or other fixed or removable medium that is read by and written to by media drive 712. As these examples illustrate, the storage media 718 may include a computer-readable storage medium having particular computer software or data stored therein.

In alternative embodiments, information storage system 710 may include other similar components for allowing computer programs or other instructions or data to be loaded into computing system 700. Such components may include, for example, a removable storage unit 722 and an interface 720, such as a program cartridge and cartridge interface, a removable memory (for example, a flash memory or other removable memory module) and memory slot, and other removable storage units 722 and interfaces 720 that allow software and data to be transferred from the removable storage unit 718 to computing system 700.

Computing system 700 can also include a communications interface 724. Communications interface 724 can be used to allow software and data to be transferred between computing system 700 and external devices. Examples of communications interface 724 can include a modem, a network interface (such as an Ethernet or other NIC card), a communications port (such as for example, a universal serial bus (USB) port), a PCMCIA slot and card, etc. Software and data transferred via communications interface 724 are in the form of signals which can be electronic, electromagnetic, and optical or other signals capable of being received by communications interface 724. These signals are provided to communications interface 724 via a channel 728. This channel 728 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’ ‘computer-readable medium’ and the like may be used generally to refer to non-transitory media such as, for example, memory 708, storage device 718, or storage unit 722. These and other forms of computer-readable media may store one or more instructions for use by processor 704, to cause the processor to perform specified operations. Such instructions, generally referred to as ‘computer program code’ (which may be grouped in the form of computer programs or other groupings), when executed, enable the computing system 700 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 700 using, for example, removable storage drive 722, drive 712 or communications interface 724. The control module (in this example, software instructions or executable computer program code), when executed by the processor 704, causes the processor 704 to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single signal processing module. However, the inventive concept may equally be implemented by way of a plurality of different functional units and processors to provide the signal processing functionality. Accordingly, it will be understood that the term ‘signal processing module’ used herein is intended to encompass one or more signal processing functional units, circuits and/or processors. Thus, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices. Thus, the elements and components of an embodiment of the invention may be physically, functionally and logically implemented in any suitable way. Indeed, the functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Thus, an improved method and apparatus for enabling a management of an access control list (ACL) of a Home NodeB (HNB) within a cellular communication network have been described, wherein the aforementioned disadvantages with prior art arrangements have been substantially alleviated.

1. A method for enabling a management of an access control list (ACL) of a Home NodeB (HNB) within a cellular communication network; the method comprising:
receiving an ACL management message originating from a subscriber unit;
identifying at least one HNB with which the originating subscriber unit of the received message is registered as being authorised to manage an ACL therefor; and
performing at least one ACL management operation for the ACL of the identified HNB in accordance with the received ACL management message.

2. The method of claim 1 wherein the method further comprises identifying the originating subscriber unit based at least partly on information contained within the received ACL management message.

3. The method of claim 2 wherein the method further comprises identifying the originating subscriber unit based at least partly on an originator Mobile Subscriber Integrated Services Digital Network Number (MSISDN) parameter within the received ACL management message.

4. The method of claim 3 wherein the method comprises identifying the at least one HNB with which the originating subscriber unit is registered as being authorised to manage the ACL therefor based at least partly on identifying at least one femto cell with which the originating subscriber unit is registered for service.

5. The method of claim 4 wherein the method comprises identifying the at least one HNB with which the originating subscriber unit is registered as being authorised to manage the ACL therefor based at least partly on identifying the at least one HNB with which the originating subscriber unit is registered with an HNB management system as being authorised to manage the ACL therefor.

6. The method of claim 5 wherein the at least one ACL management operation comprises at least one from the group consisting of:
returning identifiers of subscriber units included within the ACL of the identified HNB;
modifying the ACL of the identified HNB to add a subscriber unit thereto; and
modifying the ACL of the identified HNB to remove a subscriber unit therefrom.

7. The method of claim 6 wherein the at least one ACL management operation comprises identifying a subject subscriber unit of the ACL management message based at least partly on a subject subscriber field within the ACL management message, and obtaining subscriber profile data for the subject subscriber unit.

8. The method of claim 7 wherein the method comprises requesting subscriber profile data for the subject subscriber unit from an authentication, authorization and accounting (AAA) server of a cellular communication system.

9. The method of claim 7 wherein the subject subscriber field comprises a subject subscriber Mobile Subscriber Integrated Services Digital Network Number (MSISDN) field.

10. The method of claim 1 wherein the method further comprises previously registering at least one subscriber unit as being authorised to manage at least one ACL of at least one HNB.

11. The method of claim 10 wherein the method further comprises previously establishing an ACL management messaging service within a cellular communication system.

12. The method of claim 11, wherein the ACL management messaging service utilises at least one messaging protocol from the group consisting of:
an unstructured supplementary service data (USSD) messaging protocol; and
a short message service (SMS) messaging protocol.

13. The method of claim 12 wherein the method is implemented within an HNB management system operably coupled to the cellular communication network.

14. A Home NodeB (HNB) management system arranged to enable a management of an access control list (ACL) of at least one Home NodeB (HNB) within a cellular communication network; the HNB management system comprising at least one signal processing module arranged to:
receive an ACL management message;
identify at least one HNB with which an originating subscriber unit of the received message is registered as being authorised to manage an ACL therefor; and
perform at least one ACL management operation for the ACL of the identified HNB in accordance with the received ACL management message.

15. (canceled)

16. A non-transitory computer program product having executable program code stored therein for enabling the management of an access control list (ACL) of a Home NodeB (HNB) within a cellular communication network, the program code operable for, when executed at an HNB management system:
receiving an ACL management message;
identifying at least one HNB with which an originating subscriber unit of the received message is registered as being authorised to manage an ACL therefor; and
performing at least one ACL management operation for the ACL of the identified HNB in accordance with the received ACL management message.

17. The non-transitory computer program product of claim 16 wherein the non-transitory computer program product comprises at least one from the group consisting of: a hard disk, a CD-ROM, an optical storage device, a magnetic storage device, a Read Only Memory, ROM, a Programmable Read Only Memory, PROM, an Erasable Programmable Read Only Memory, EPROM, an Electrically Erasable Programmable Read Only Memory, EEPROM, and a Flash memory.
